(19) United States
(12) Patent Application Publication
(10) Pub. No.: US 2006/0015522 A1
(43) Pub. Date: Jan. 19, 2006

(54) Methods and systems for preservation of fixed pegging

(76) Inventors: Klaus Reinelt, Kraichtal (DE); Stefan Siebert, Hockenheim (DE); Christoph Glania, Muehlhausen-Rettigheim (DE); Stephan Hetzer, Angelbachtal (DE); Thomas Schumacher, Heidelberg (DE); Peter Engel, Leimen (DE); Guenter Pecht-Seibert, Muehlhausen (DE); Thorsten Kulick, Bensheim-Schoenberg (DE); Joachim Altmeyer, Leimen (DE); Andre Doerfler, Mannheim (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/025,058

(22) Filed: Dec. 30, 2004

(30) Foreign Application Priority Data
Jun. 18, 2004 (EP) 04076801.2

(51) Int. Cl. G06F 17/00

(52) U.S. Cl. 707/102

(57) ABSTRACT

A method for providing a planning framework for use in managing a material flow of products in a supply chain. According to the method, subsequent instances of said material flow are associated with linked documents in a document flow. In a prior document, first relations are established identifying one or more dependent documents, for producing one or more products in a next instance of said material flow. Said prior document is converted into said next document in a forward way. According to the invention, the method comprises establishing in said next document the first relations identifying said one or more dependent documents, so as to convert said next document into said prior document in a reverse way. In this way, fixed relations can be preserved between product requirements and products while changing the material flow.

### RELATED APPLICATIONS

This application is based upon and claims the benefit of priority from prior patent application EP 04076801.02, filed Jun. 18, 2004, the entire contents of each are expressly incorporated herein by reference.

### BACKGROUND

I. Technical Field

The present invention relates to a method for providing a planning framework for use in managing a material flow to be planned in a supply chain.

II. Background Information

Typically, in a supply chain planning strategy, an aspect is inventory management, which can be defined as bringing requirement tasks in conformity with available stock, in other words, matching a supply and demand of goods in a production chain where available stock is used to cover stock requirements.

A further aspect of this matching supply and demand of material goods is keeping track material flow, wherein order prescriptions are met with available stock batches. In this respect, the major enterprises where planning of material flow plays a crucial role in the production and manufacturing of goods, which encompasses almost all branches of the industry, use IT-systems such as for example supply chain management systems developed by SAP AG.

Certain functional features of these IT-systems may be involved with structures that describe the material flows between product receipt documents (purchase orders, purchase requisitions, planned orders, production orders and stocks) and product requirement documents (sales orders, planned independent requirements, dependent requirements and stock transport requirements). The assignment of material flows between product requirement documents and product receipt documents is also referenced as “pegging”. Hence, if a material flow is possible between two documents, a pegging relationship is present between said documents. Such possibility exists for example, if the product, location, account assignment and planning version of the orders are the same. If this is not the case, a pegging relationship is not present.

The quantities of product receipt documents and product requirement documents can deviate from each other. A product requirement document may have to be covered by several product receipt documents. A product receipt document can also cover several product requirement documents. The relationship between product receipt documents and product requirement documents is therefore an n:n relationship. In this respect, the succession from a prior product requirement document in a first instance of a document flow to a next product requirement document in a next instance of the document flow is related in a way so that, from the prior product requirement document, the supply chain management program generates a next product requirement document in a next instance of the document flow.

Thus a document flow is produced by representing subsequent instances of said document flow as linked nodes in a network, wherein the nodes are objects representing documents at the requirement and receipt side of the supply chain.

In this way, forwardly, the material flow of products is represented as pegging relations in a said document flow, which identify that relate prior product requirements to next product requirements. If, for example, one document flow is created at the requirement side and another at the receipt side, pegging relations can be used to describe the material flow between both document flows.

One of the problems associated with these pegging relationships is the fact that they are heavily dependent on an actual planning. That is, if in the planning a particular item is changed, that is, an order is cancelled or a stock becomes unavailable, the pegging relationships are destroyed and a deficiency arises in the way a material flow is monitored. This gives rise to stock problems, which may cause over or under stocking of materials. These problems can cause a big problem for actually executing a particular process according a planning status prescribed by the system if stock is not available at the time and places when needed, or if the stock becomes redundant if orders are cancelled. Also, in a material flow, the planning order gives rise to conversions, that have to be accounted for in the planning. For instance, a purchase requisition may have to be converted in a purchase order, wherein several requisitions may be combined in one order. This involves canceling of the requisitions and adding of orders in the material flow. To keep track of the pegging relationships under such conditions has hitherto not been made available.

It is therefore an object of the invention to provide a method and system that copes with the above described problems and that provides a robust solution for keeping track of material flow, even when specific items in these flows are added or cancelled.

### SUMMARY

Consistent with the present invention, a method provides a planning framework for use in managing a material flow of products in a supply chain. The method comprises: associating subsequent instances of said material flow with linked documents in a document flow; establishing in a prior instance of said document flow, in a prior document, first relations identifying one or more dependent documents, for producing one or more products in a next instance of said material flow; converting said prior document into a next document in a forward transition; and establishing in said next document, said first relations identifying said one or more first dependent documents, so as to convert said next document into said prior document in a reverse transition.

Consistent with the present invention, a computer system for provides a planning framework for use in managing a material flow of products in a supply chain. The computer system comprises: a computer architecture representing subsequent instances of said material flow as linked documents in a document flow; and a module operative on said computer architecture, arranged to establishing in a prior instance of said document flow, in a prior document, first relations identifying one or more first dependent documents, for producing one or more products in a next instance of said material flow, wherein said module further arranged to convert said prior document into a next document in a forward transition; wherein said module is further arranged to establishing in said next document, said first relations identifying said one or more first dependent documents, so as to convert said next product requirement into said prior in a reverse transition.

y establishing in said next document, said first relations identifying said one or more first dependent requirement documents, said next document can be converted back into said prior document in a reverse transition, while keeping pegging relations intact Hence, in reverse mode, the material flow can be rebuilt if a particular product requirement is cancelled or altered due to changes in an actual material flow planning, so that fixed relations can be preserved between product requirements and products while changing the material flow.

Thus, by preservation of these prior pegging relationships, the relationships can be maintained even if in actual planning changes, certain pegging relations have to be re-established. Note that this is not the same as identifying anew these pegging relations dynamically, since in such case, the relationships are built without using information regarding the old pegging relationships.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 displays a first scenario according to the method of the invention;

FIG. 2 displays a chain of sequence steps for performing the scenario in FIG. 1;

FIG. 3 displays a second scenario according to the method of the invention;

FIG. 4 displays a third scenario according to the method of the invention; and

FIG. 5 displays an exemplary fourth scenario in sequential steps according to the method of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

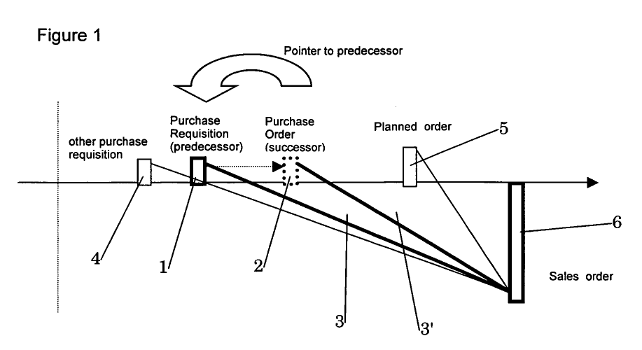

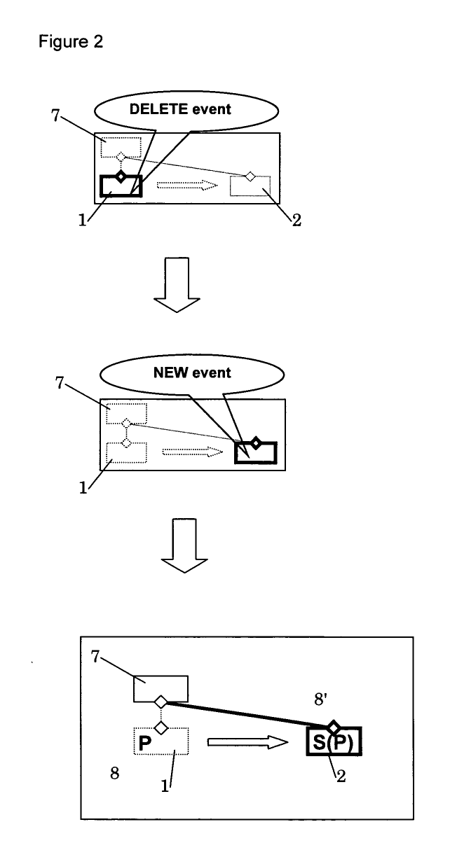

Turning now to FIG. 1, a purchase requisition 1 is to be converted in a purchase order 2 while pegging relations 3 are converted into 3′ intact. In this aspect, the term purchase order can be described as a request or instruction from a purchasing organization to a vendor (external supplier) or a plant to deliver a certain quantity of a product or to perform certain services at a certain point in time. Such a purchase order 2 may exist in a supply chain management program in the form of a node in a document flow. Prior to the purchase order 2, a requirement may be registered in the supply chain management program as an undecided proposal to purchase some product. Such purchase requisitions 1 may also be created automatically. Thus, sequentially, in a material flow, a purchase requisition 1 is to be converted into a purchase order 2, which results in additions and deletions of the aforementioned network representing the material flow as will be further explained with reference to FIG. 2. Specifically, the purchase requisition 1 is the predecessor of the purchase order 2 in such a network, and pegging relationships are identified that relate the prior product requirement (purchase requisition 1) to next product requirement (purchase order 2). Thus, the product requirements (1, 2) are formed as nodes in a network, representing subsequent instances or stages in the flow. In this aspect, product requirements 1, 2 are used to list a category of products that are required for a subsequent stage in the material flow, so that, in the example in FIG. 1, the purchase requisition 1 and subsequent purchase order 2 are both viewed generally as “product requirements” that are changed in the course of the documents flow/material flow. In the document flow, the purchase requisition 1 is deleted and converted into a purchase order 2 by adding a new product requirement in the form of the purchase order 2. In the next instance of the material flow, this purchase order 2 may be combined with other purchase requisitions 4 (or converted counterparts) and planned orders 5 into a final sales order 6.

To preserve the material flow to the sales order 6, the fixed pegging relationships must be reassigned to the successor purchase order 2. The successor purchase order 2 therefore, according to the invention, identifies the pegging relations 3 of the purchase requisition 1 identifying the required products, so as to be able to generate the product requisition from the purchase order in a reverse way and to transfer the pegging relations from the purchase requisition 1 to the purchase order 2. In this way, in the purchase order 2 the predecessor 1 is identified as a new parameter. This information points to the correct purchase requisition 1, from which the quantities of material flow are to be taken over.

FIG. 2 shows the subsequent steps of addition and deletion of product requirement nodes 1, 2 and 3 in the document flow network indicated before. The example concerns handling a transition in the document flow wherein a purchase requisition 1 is converted into a purchase order 2. To this end, product requirements are represented as nodes 7 in a document flow 8. Thus, the transition is realized by deleting, in a first function call the node representing the purchase requisition 1, after collecting the node 1 being the predecessor P of node 2, identified as the successor S(P) of the predecessor P in the buffer. Thus, in the buffer the purchase requisition P and the pegging relationships thereof are temporarily stored.

Then, in a second remote function call a new node 2 is added to the flow 8, representing the purchase order. Further, the node of purchase order 2 and predecessor information of purchase requisition 1 are collected into the buffer.

This next function call triggers re-calculation of the fixed pegging relationships, wherein all affected document nodes are determined and sorted by predecessor information. The result is a new node representing the purchase order 2, with pegging relationships kept intact. Alternatively, first and second function calls could be executed in reverse order, so that first the purchase order node 2 is added prior to deleting the purchase requisition node 1.

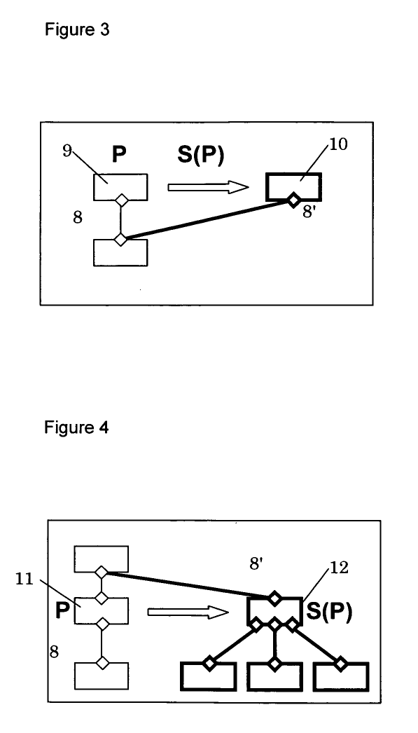

FIG. 3 shows another scenario wherein the pegging relationships are kept intact according to the method of the invention. While the document flow scenario represented in FIGS. 1 and 2 concern transitions art the receipt side (in the example: a conversion of a purchase requisition into a purchase order), also at the requirement side these transitions may occur and pegging relations may be wanted to be kept intact. Thus FIG. 3 shows the transitions of for example a sales order 9 into a delivery 10. Also here, the sales order 9 is the predecessor P of the delivery 10 S(P). The conversion in the document flow network 8 is handled in a way similar as illustrated with reference to FIG. 2.

FIG. 4 shows another scenario where pegging relationships are modified. In this example, in for example in-house production, a batch production order 11 is converted for creating splitted dependent requirement documents to split the material flow into smaller units, for example, to be in correspondence with existing resources. Thus in the prior configuration 8, the batch is not split and pegging relations are identified in the production order 11. In the transition, the document flow is split into three in a next configuration 8′, and pegging relationships are maintained in the modified batch production order 12, being the successor S(P) of the predecessor P, the prior production order 11.

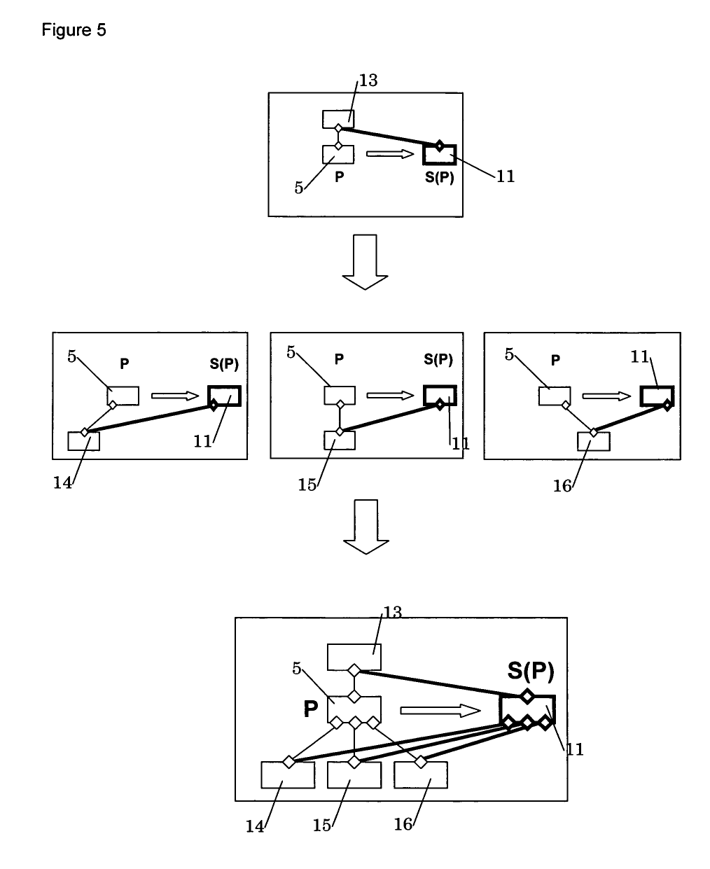

In FIG. 5 pegging relations of several documents are combined into one follow on document S(P). This scenario may occur when for example a planned order 5 (P) is converted into a production order S(P), similar to the combination explained in FIG. 1 concerning the combination of several purchase requisitions 1, 4. In the first step, the order output 13 (for example, a sales order) is examined and pegging relations are transferred from the planned order 5, the predecessor P, to the successor S(P), that is, for example, the production order 11.

In a next step, the inputs are examined, and a first order input 14 (for example, stock documents) is examined. Then, a next order input 15 and a third order input 16 are examined and pegging relations are transferred to the successor 11.

While the invention is described with reference to the embodiments disclosed in the figures it is no way limited thereto but only is presented for illustrative purposes. The computational aspects described here can be implemented in digital electronic circuitry, or in computer hardware, firmware, software, or in combinations of them. Where appropriate, aspects of these systems and techniques can be implemented in a computer program product tangibly embodied in a machine-readable storage device for execution by a programmable processor, and method steps can be performed by a programmable processor executing a program of instructions to perform functions by operating on input data and generating output.

The invention may also be implemented in an article of manufacture with a computer usable medium having computer readable instructions embodied therein for providing access to resources available on that computer, the computer readable instructions comprising instructions to cause the computer to perform a part of a method according to the invention. The invention may also be implemented as a computer program for running on a computer system, at least including code portions for performing steps of a method according to the invention when run on a computer system or enabling a general propose computer system to perform functions of a filter device according to the invention. Such a computer program may be provided on a data carrier, such as a CD-ROM or diskette, stored with data loadable in a memory of a computer system, the data representing the computer program. The data carrier may further include a data connection, such as a telephone cable or a wireless connection transmitting signals representing a computer program according to the invention.

While certain features and embodiments of the invention have been described, other embodiments of the invention will be apparent to those skilled in the art from consideration of the specification and practice of the embodiments of the invention disclosed herein. It is intended, therefore, that the specification and examples be considered as exemplary only, with a true scope and spirit of the invention being indicated by the following claims and their full scope of equivalents.

What is claimed is:

1. A method for providing a planning framework for use in managing a material flow of products in a supply chain, comprising:
associating subsequent instances of said material flow with linked documents in a document flow;
establishing in a prior instance of said document flow, in a prior document, first relations identifying one or more dependent documents, for producing one or more products in a next instance of said material flow;
converting said prior document into a next document in a forward transition; and
establishing in said next document, said first relations identifying said one or more first dependent documents, so as to convert said next document into said prior document in a reverse transition.

2. The method according to claim 1, wherein said document transition between said first instance and said next instance in said document flow represents a conversion of a product requirement document at a requirement side of the material flow.

3. The method according to claim 2, wherein said product requirement document is a sales order to be converted into a delivery document.

4. The method according to claim 1, wherein said document transition between said first instance and said next instance in said document flow represents a conversion of a product receipt document at a receipt side of the material flow.

5. The method according to claim 4, wherein said product receipt document is a purchase requisition to be converted into a purchase order.

6. The method according to claim 1, wherein said document transition between said first instance and said next instance in said document flow represents converting a document to a plurality of documents associating splitting of said material flow.

7. The method according to claim 6, wherein said document is a in-house production order that is converted for creating splitted dependent requirement documents.

8. The method according to claim 1, wherein said document transition between said first instance and said next instance in said document flow represents the generation of a follow on document concerning receipt and requirement document nodes.

9. A computer system for providing a planning framework for use in managing a material flow of products in a supply chain, comprising:
a computer architecture representing subsequent instances of said material flow as linked documents in a document flow; and
a module operative on said computer architecture, arranged to establishing in a prior instance of said document flow, in a prior document, first relations identifying one or more first dependent documents, for producing one or more products in a next instance of said material flow,
wherein said module further arranged to convert said prior document into a next document in a forward transition; wherein said module is further arranged to establishing in said next document, said first relations identifying said one or more first dependent documents, so as to convert said next product requirement into said prior in a reverse transition.

10. The computer system according to claim 9, comprising a client-system at which user interface is present and at least one server-system communicatively connected to said client-system, which server-system is arranged for comprising said architecture and arranged for running said modules.
